(19) United States
(12) Patent Application Publication
(10) Pub. No.: US 2013/0241879 A1
(43) Pub. Date: Sep. 19, 2013

(54) OPTICAL TOUCH MODULE

(71) Applicants: HSUEH-YU LU, New Taipei City (TW); Ke-Feng Lin, New Taipei City (TW)

(72) Inventors: HSUEH-YU LU, New Taipei City (TW); Ke-Feng Lin, New Taipei City (TW)

(73) Assignee: Cheng Uei Precision Industry Co., LTD., New Taipei City (TW)

(21) Appl. No.: 13/420,483

(22) Filed: Mar. 14, 2012

(51) Int. Cl. G06F 3/042

(52) U.S. Cl. 345/175

(57) ABSTRACT

An optical touch module includes a frame that comprises a plurality of side walls and an operating space formed by the plurality of side walls. A display module is disposed inside the frame, the display module comprises a base and a touch panel being disposed on the base, a first interval and a second interval being formed opposite to each other and between the base and the side walls of the frame, the touch panel being located adjacent to the operating space. At least one light sensing device comprises a fixed part and a detection part, and the light sensing device is located inside the first interval. At least one reflective element is disposed on the second interval, and comprises a reflective surface defined in a same horizontal plane as the detection part and oriented to the detection part.

### BACKGROUND OF THE INVENTION

1. Field of the Invention

The present invention generally relates to a touch module, and in particular to an optical touch module having a simple structure and reduced thickness.

2. The Related Arts

The technologies of touch panel are various, and their applications range increasingly wider because of improving process and quality. In particular, the development of the optical touch technology brings the touch technology into a new field. Compare to other technologies, types of the optical touch technology are much advantaged of accuracy, high penetration rates, low damage rates, low production cost and being supportive to multiple touch control gestures and so on.

The optical touch technology is in use of the principle of light receiving and interrupting. When objects interrupt light, through the coordination of sensors and the reflective elements judging axis, the precise touch positions can be read. However, the traditional optical touch modules are installed on a touch glass, but the touch glass, a liquid crystal display (LCD) and base are spaced form each other. Therefore, a gap between a traditional optical touch screen and a base is huge which increases thickness in assembly, and causes the assembly process to be difficult, and a high manufacturing cost. Besides, a thick configuration does not meet the need of thin and light design in the market. In addition, the touch glass disposed upon LCD result in not only inconvenience with repair but also damage to sensors and reflective elements.

### SUMMARY OF THE INVENTION

An objective of the present invention is to provide an optical touch module having advantages of simple structure, thin and easy to use.

To achieve the above objective, an optical touch module of the present invention comprises a frame comprising of a plurality of side walls and an operating space formed by the plurality of side walls. A display module is disposed inside the frame, the display module comprise a base and a touch panel being disposed on the base, a first interval and a second interval being formed opposite to each other and between the base and the side walls of the frame, the touch panel being located adjacent to the operating space. At least one light sensing device comprises a fixed part and a detection part, and the light sensing device is located inside the first interval. At least one reflective element is disposed on the second interval and comprises a reflective surface defined in a same horizontal plane as the detection part and oriented to the detection part.

As described above, the optical touch module of the present invention has advantages of significantly reducing whole thickness for structure and saving manufacturing cost.

### BRIEF DESCRIPTION OF THE DRAWINGS

FIG. 1 is a schematic cross-sectional view of the first embodiment of the present invention;

FIG. 2 is a schematic cross-sectional view of the other embodiment of the present invention; and

FIG. 3 is a schematic cross-sectional view of the other embodiment of the present invention.

### DETAILED DESCRIPTION OF PREFERRED EMBODIMENT

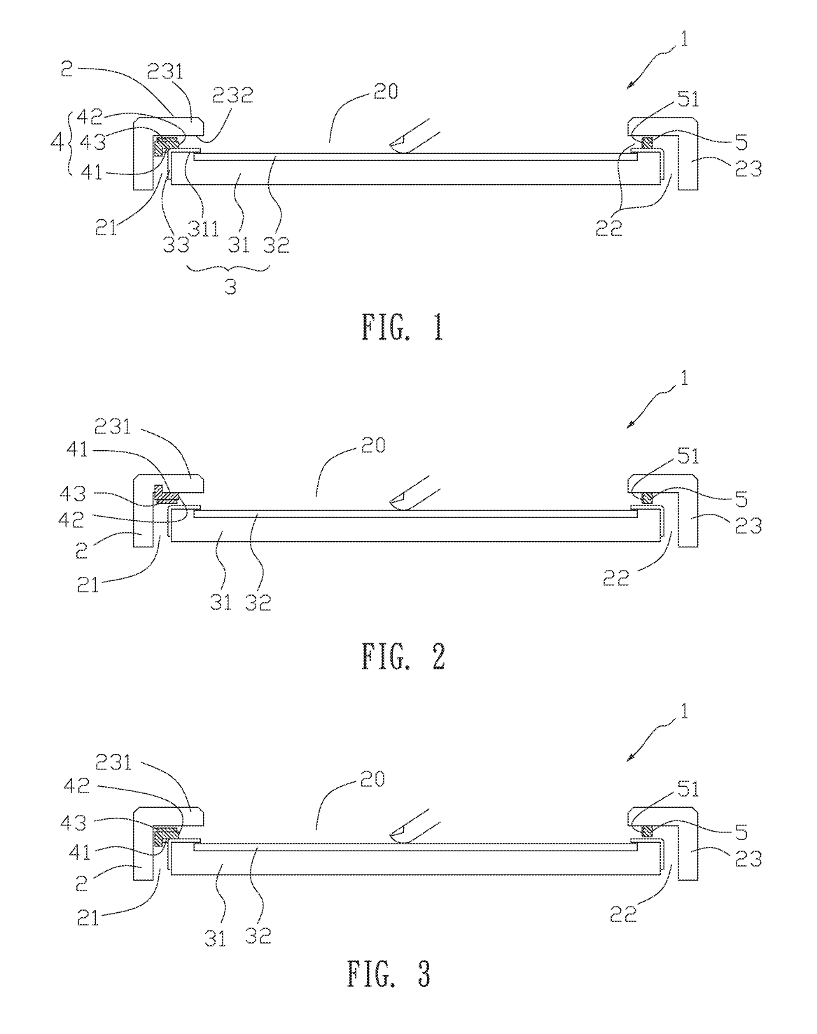

With reference to FIG. 1, the first embodiment of the present invention is shown in a schematic cross-sectional view. An optical touch module 1 of the present invention is used for image display and is operated or controlled by single-point or multiple-point touch control. The optical touch module 1 comprises a frame 2, a display module 3, two light sensing devices 4, and a plurality of reflective elements 5. The frame 2 comprises of a plurality of side walls 23, and a rectangular frame is formed by the plurality of side walls 23 while the shape of the frame is not limited. The space form by the plurality of side walls 23 defines an operating space 20 therein. Frame edges 231 protrude into the operating space 20 from the plurality of side walls 23. The plurality of side walls 23 comprises an inner wall face 232. In other word, the plurality of side walls 23 and the corresponding frame edge 231 form a profile of an inverted “L” together in a cross sectional view thereof.

The display device 3 is assembled inside the frame 2, and comprises a base 31, a touch panel 32 that is located at the base 31. A first interval 21 and a second interval 22 being formed opposite to each other and between the base 31 and the side walls 23 of the frame 32. In other words, the frame edges 231 are located above the first intervals 21 and second intervals 22, and have inner wall faces, respectively, and the inner wall faces are parallel to the touch panel 32. In particular, the touch panel 32 being located adjacent to the operating space 20, therefore, there is no other components are located above the touch panel 32. The underside that is one side of the operating space 20 of the touch panel 32 is connected to the base 31 electrically. In this embodiment, the touch panel 32 is a liquid crystal display (LCD). Besides, wherein a positioning plate 22 are provided on peripheral sides 311 of the base 31 adjacent to the touch panel 32 (Referring to FIG. 1).

Further referring to FIG. 1, the optical touch module 1 of the present invention comprises two light sensing devices 4 respectively located inside the first interval 21. The frame edge 24 is located above the light sensing devices 4 to function as a cover and protection of the light sensing devices 4. Each of the light sensing devices 4 comprises a fixed part 41, a detection part 42 and it connected to a touch integrated circuit (IC) (No Figure). In this embodiment, the detection part 42 is a camera device that is in the corner of the display device 3. The fixed part 41 is settled on the positioning plate 33 of the base 31 and spaced apart from frame 2. The detection part 42 is facing toward the operating space 20.

Each of the plurality of reflective elements 5 comprises a frame edge that is located inner the first interval 21 and the second interval 22 and fixed on the positioning plate 33 of the second interval 22. The reflective surface 51 is roughly located at the same horizontal plane as the detection part 42, and oriented to the detection part 42.

In this embodiment, the plurality of reflective elements 6 can be reflective strips distributed over the part of margin of the base 31, the detection part 42 detects and senses the light reflected by the reflection strips of the plurality of reflective elements 5. In addition, the generation of light source 43 of the present invention can be a light emitting diode (LED) element (Referring to FIG. 1) or other light emitting element, the light emitted passes through the operating space 20 to the reflective elements 5. The light emitting element 43 is disposed on or adjacent to the light sensing devices 4.

With reference to FIG. 2 showing the other embodiment of the present invention, the light sensing devices 4 and the reflective elements 5 is located above the frame 2 of the first interval 21 and the second interval 22 separately and keeps space from the display device 3. The fixed part 41 of the light sensing devices 4 and the reflective elements 5 adjacent to the inner surface 231 of frame edge 23, and the frame edge of reflective elements 5 aims at the detection part 42.

With referring to FIG. 3 showing the other embodiment of the present invention, the configuration of light sensing device 4 and the reflective elements 5 can also be installed the way that the light sensing device 4 is located on the base 31 and spaced apart from frame 2, the reflective elements 5 is located on frame edge 231 of the frame 2 and spaced apart from the base 31, and the frame edge of reflective elements 5 oriented to the detection part 42.

In use of the present invention, through the principle of light received and interrupted, when there are objects (such as fingers) interrupting light of the operating space 20 and touching the touch panel 32, the light sensing device 4 detects shading change and operates calculations by touch integrated circuit (IC) to determines the touched location precisely.

Accordingly, the optical touch module 1 of the present invention don't need install a layer of traditional touch glass, we can touching the LED touch panel directly. It can reduce the overall thickness significantly and reduce manufacturing costs. In addition, the light sensing device and reflective element of the present invention are not located above touch panel, but located above base or frame, therefore, not only panel without damages to the display device 4, but also convenient to whole maintenance process.

The above detailed descriptions are only illustrative for one feasible embodiment of the present invention. However, the illustrative embodiment is not intended to limit the scope of claims of the present invention. It is apparent to those skilled in the art that a variety of modifications and changes may be made without departing from the scope of claims of the present invention which is intended to be defined by the appended claims.

What is claimed is:

1. An optical touch module, comprising:
a frame having a plurality of side walls, an operating space formed by the plurality of side walls;
a display module being disposed inside the frame, and comprising a base and a touch panel being disposed on the base, a first interval and a second interval being formed opposite to each other and between the base and the side walls of the frame, the touch panel being located adjacent to the operating space;
at least one light sensing device comprising a fixed part and a detection part, and being located inside the first interval; and
at least one reflective element being disposed within the second interval, and comprising a reflective surface located at the same horizontal plane as the detection part, and oriented to the detection part.

2. The optical touch module as claimed in claim 1, wherein the side walls of the frame protrudes a frame edge into the operating space , respectively, the frame edges are located above the first and second intervals, and have inner wall faces, respectively, and the inner wall faces are parallel to the touch panel.

3. The optical touch module as claimed in claim 1, wherein the fixed part of the light sensing device and the reflective element are disposed on the base, and spaced apart from the frame.

4. The optical touch module as claimed in claim 3, wherein a positioning plates are provided on peripheral sides of the base adjacent to the touch panel, and the fixed part of the light sensing device and the reflective element are installed on the positioning plates, respectively.

5. The optical touch module as claimed in claim 1, wherein the fixed part of the light sensing device and the reflective element are attached to the frame and spaced apart from the display module.

6. The optical touch module as claimed in claim 1, wherein the fixed part of the light sensing device is located on the base spaced apart from the frame, and the reflective element is attached to the frame and spaced apart from the base each other.

7. The optical touch module as claimed in claim 1, wherein the touch panel is a liquid crystal display.
